(19) United States
(12) Patent Application Publication
(10) Pub. No.: US 2022/0343483 A1
(43) Pub. Date: Oct. 27, 2022

(54) SYSTEM AND METHOD FOR PROBABILISTIC DETERMINATION OF LIKELY GRADE OF COLLECTIBLE CARDS

(71) Applicant: Veery, LLC, Yardley, PA (US)

(72) Inventor: Chintan Desai, Yardley, PA (US)

(21) Appl. No.: 17/236,406

(22) Filed: Apr. 21, 2021

(51) Int. Cl. G06T 7/00; G01N 21/88; G06K 9/46; G06T 5/00; G06Q 30/02

(52) U.S. Cl. CPC G06T 7/0002; G01N 21/8851; G06K 9/4609; G06T 5/002; G06T 5/003; G06T 5/007; G06Q 30/0206; G06Q 30/0278; G01N 2021/8854; G01N 2021/8887

(57) ABSTRACT

The present disclosure relates to a system and method for determining a like grade and value or range of values for collectible cards. The system is configured to perform a method comprising: providing a graded card database comprising identifying attributes, physical characteristics, and grade information of each of graded cards, wherein the grade information comprises grade and corresponding grading entity of the graded cards; receiving at least one image of an object card; determining identifying attributes and physical characteristics of the object card based on the at least one image; selecting, from the graded card database, a comparison group including potentially a plurality of comparison cards based on the identifying attribute of the object card; determining a similarity between the object card and each comparison card based on the physical characteristic; and determining a likely grade for the object card based on the similarity. A card value database with information of traded card may be additionally provided and a likely value or range of values may be determined.

### TECHNICAL FIELD

The application relates to the field of a system and method for probabilistic determination of likely grade of collectible cards. More specifically, the application relates to a computerized system for estimating a grade for any collectible sport and non-sport card and other printed objects including event ticket, programs, photographs, and the like.

### BACKGROUND

Card collecting, including sport and non-sport cards, has become much more than a hobby. In fact, many are considering this to be a new asset class for potential investment. Therefore, card collecting and investing is a growing, multi-billion dollar market. Cards can be traded either graded or ungraded (also referred to as “raw”). The condition of the card significantly affects its value as a collectible. As such, it is very common for cards, as well as other collectible objects, to be professionally evaluated (“graded”) by industry recognized experts and independent third-party companies, collectively the “Grading Companies.” Graded cards are cards which have been evaluated and certified for authenticity and quality by the Grading Companies. For example, the most prominent amongst them in sport card grading are Professional Sports Authenticators (“PSA”), Beckett Grading Services (“BGS”), Sportscard Guaranty Corporation (“SGC”), and Certified Sports Guaranty (“CSG”). Usually, cards are graded on a scale from 1 to 10, with 10 being the best, and all Grading Companies score cards based on their evaluation of four common elements: centering, surface conditions (i.e., if the object has any defects such as dimples, scratches, visible print lines), condition of edges, and condition of corners. In instances of autograph cards, there is also a separate grade to help establish the quality of the signature (i.e. authenticity and if there are any streaks in the signature). Once cards are graded, they are housed by the Grading Company in a tamper-proof “slab”, a plastic case which includes both the card and a label stating the grade and other identifying information, such as card year, manufacturer, card number, card set, Grading Company serial number, and other identifying characteristics of the card (e.g., holographs).

Raw card prices are by their nature more volatile than graded cards because the quality of raw cards can vary greatly and they are difficult to assess, which is not the case with graded cards that have had their quality evaluated by a Grading Company, and preserved by each Grading Company's protective slab. In theory, cards of a given grade should have similar/standardized characteristics across the common elements listed above.

Graded cards are therefore highly valued, because buyers and sellers can trust that a graded card is authentic and represents a certain quality. Owners and potential buyers of raw cards want to maximize the value of a given card and so are incentivized to grade their cards because graded cards often fetch a significant premium relative to raw card's prices. While submitting raw cards for grading can be lucrative, it carries significant risks, because it can be an expensive endeavor while the outcome (the grade) is uncertain and the expected turnaround from the Grading Companies can lengthy and in some instances be close to a year, at which point the volatile market can look completely different than at the time of submission. There are services levels that will allow for faster turnaround times, but these can be extremely cost prohibitive (shorter turnarounds can cost hundreds to thousands of dollars per card). Grading Companies are not always consistent and therefore can grade any given card differently based on the Grading Company, it's personnel, or the year in which it was graded. This directly impacts the value of the graded card. Owners and potential buyers of raw cards therefore must be judicious when deciding which raw card they will submit and to which company in order to maximize their return on investment.

One of the most important factors in the value determination of a raw card is its physical condition, since that is the key factor in grade determination by the Grading Companies through their in-house experts. However, most buyers and sellers do not possess the skill or ability to evaluate raw cards, so the market is inefficient. The evaluation process becomes even more difficult in online transactions (for which hundreds of thousands take place yearly), where the photo quality is not standardized and sellers are not incentivized to divulge flaws in a raw card.

Due to the subjectivity of Grading Companies in assigning grades to cards through human judgement (sometimes with the aid of a computerized system), owners and buyers of graded cards are also incentivized to ask for help in evaluating their cards for potential resubmission. Resubmission presents an opportunity to obtain a better grade and thereby potentially significantly increase the value of their card (in many cases, the value of the card can increase by multiples). In addition, counterfeiting is a serious problem in the industry—where cards have been manipulated to obtain higher grades and/or slabs have been fabricated to “fake” a grade.

There exists the need for a decision support tool that collectors and investors may use to estimate the graded score or potential market value of a card before a collector submits or resubmits the card for evaluation.

### SUMMARY

This disclosure provides a system and method for creating a proprietary assessment and valuation estimate for collectible cards. Provided is a measure of predictability to aid in the decision of submitting cards for grading, so that users can assess the cost vs. benefit in whether they should submit a card for grading, or purchase a card with the intent to grade. The system and process does not seek to replace Grading Company scores, but rather, provide independent insight to a user as to the likely outcomes of a submission.

The disclosure includes a proprietary database of sourced card images and their corresponding data and attributes, a user submission of card image, a filtering algorithm to obtain a comparable group of cards to the user's submitted card (“object card”), a similarity assessment of the submitted card to the comparable group, and an estimate of grade and/or potential value. The data in the database can include but is not limited to identifying attributes such as card manufacturer, card vintage, subject, card number, parallel type (for example, base, holographic, rare refractor, and other design elements), and physical card attributes such as size, corners, centering, edges, visible scratches/other damage, and rarity. For a given card, the process begins with the user's submission of a card image to the system (the “submitted card” or “object card”). The algorithm filters the database to determine a subset of similar cards based on the attributes described above and evolved through machine learning, hereafter called the “comparison group”. The second algorithm then compares the submitted card to the comparison group to assess how similar the submitted card is to the comparison group, in order to assign a “Similarity Score” to the card. The Similarity Score is a range of estimated grades and the probability of receiving that grade, based on the submitted card's similarity to cards of the same grade in the comparison group. This similarity score will also inform an estimate of the grade or even potential value of the card if graded, based on recent and relevant transactions in the marketplace.

According to one aspect of the present invention, a method for probabilistic determination of a likely grade for a collectible card may comprise: providing a graded card database comprising identifying attributes, physical characteristics, and grade information of each of graded cards, wherein the grade information comprises grade and corresponding grading entity of the graded cards; receiving at least one image of an object card; determining identifying attributes and physical characteristics of the object card based on the at least one image; selecting, from the graded card database, a comparison group including, potentially, a plurality of comparison cards based on the identifying attribute of the object card; determining a similarity between the object card and each comparison card based on the physical characteristic; and determining a likely grade for the object card based on the similarity.

According to one aspect of the invention, the identifying attributes may comprise one of subject matter, manufacturer, vintage, and parallel type; and selecting the comparison group may comprise selecting a plurality of comparison cards that each have at least one same attribute as that of the object card. In addition, the comparison group may comprise a plurality of comparison cards having a range of grades selected within 1-10.

According to one aspect of the invention, determining a similarity may comprise of determining a similarity score in each characteristic between the object card and each comparison card; and determining an overall similarity score between the object card and each comparison card based on the similarity scores in all characteristics. Determining an overall similarity score may further comprise determining an overall similarity score between the object card and each comparison card based on the similarity scores of each characteristic and a weight assigned to each characteristic. Furthermore, determining the likely grade may comprise identifying at least one comparison card having a highest overall similarity score to the object card, and reporting a grade of the at least one comparison card as the likely grade.

According to one aspect of the invention, the characteristics may comprise one of edge, corner, centering, and surface defects.

According to one aspect of the invention, the graded card database may further comprise at least one image of at least some of the graded cards. Furthermore, determining a similarity may comprise determining a similarity score between the object card and each of comparison cards by comparing the at least one image of the object card and at least one image of the comparison card.

According to one aspect of the invention, receiving at least one image of an object card may further comprise: receiving at least one candidate image of the object card; attempting recognition of edges and corners of the object card in the candidate image, and adjusting the candidate image; and determining whether the adjusted candidate image meets a predetermined requirement. In addition, receiving at least one image of an object card may further comprise: if the candidate image meets the predetermined requirement, taking the candidate image as the image of the object card; and if the candidate image does not meet the predetermined requirement, requesting resubmission of a candidate image.

According to one aspect of the invention, providing the graded card database may comprise obtaining data by at least one of: retrieving data from public websites and social media platforms, receiving data from grading entities, and receiving data from a user. In addition, providing the graded card database may further comprise, when obtained data comprises an image of a graded card, processing the image into a standardized image. Furthermore, processing the image may comprise processing the image through at least one of contrast enhancement, image enhancement, noise reduction, edge detecting and sharpening, alignment, and resizing.

According to one aspect of the invention, the method may further comprise: providing a card value database comprising grade information, identifying attributes, and price of each transacted card; selecting one or more value comparison cards from the card value database based on the identifying attributes and the likely grade of the object card; and determining a likely range of values of the object card based on the likely score and the identifying attributes of the object card. In addition, providing the card value database may comprises obtaining data by at least one of retrieving data from public and private marketplaces, receiving data from grading entities, and receiving data from a user.

In another aspect of the invention, a system for probabilistic determination of a likely grade for a object card may comprise: a computing device; and a graded card database comprising identifying attributes, physical characteristics, and grade information of each of graded cards, wherein the grade information comprises grade and corresponding grading entity of the graded cards; wherein the computing device comprises at least one processor and memory coupled to the at least one processor, the memory comprising computer executable instructions that, when executed by the at least one processor, performs a method comprising of: receiving at least one image of an object card; determining identifying attributes and physical characteristics of the object card based on the at least one image; selecting, from the graded card database, a comparison group including, potentially, a plurality of comparison cards based on the identifying attribute of the object card; determining a similarity between the object card and each comparison card based on the physical characteristic; and determining a likely grade for the object card based on the similarity.

According to another aspect of the invention, the identifying attributes comprise at least subject matter, manufacturer, vintage, and parallel types; and wherein selecting the comparison group comprises selecting, potentially, a plurality of comparison cards that each have at least one same attribute as that of the object card. In addition, the comparison group may comprise a plurality of comparison cards having a range of grades selected within 1-10.

According to another aspect of the invention, determining a similarity may comprise: determining a similarity score in each characteristic between the object card and each comparison card; and determining an overall similarity score between the object card and each comparison card based on the similarity scores in all characteristics. Furthermore, determining an overall similarity score may further comprise determining an overall similarity score between the object card and each comparison card based on the similarity scores of each characteristic and a weight assigned to each characteristic. In addition, determining the likely grade may comprise identifying at least one comparison card having a highest overall similarity score to the object card, and reporting a grade of the at least one comparison card as the likely grade.

According to another aspect of the invention, the characteristics may comprise at least one of edge, corner, centering, and surface defects.

According to another aspect of the invention, the graded card database may further comprise at least one image of at least some of the graded cards. In addition, determining a similarity may comprise determining a similarity score between the object card and each of comparison cards by comparing the at least one image of the object card and at least one image of the comparison card.

According to another aspect of the invention, receiving at least one image of an object card further comprises: receiving at least one candidate image of the object card; attempt recognition of edges and corners of the object card in the candidate image, and adjusting the candidate image; and determining whether the adjusted candidate image meets a predetermined requirement. In addition, receiving at least one image of an object card may further comprise: if the candidate image meets the predetermined requirement, taking the candidate image as the image of the object card; and if the candidate image does not meet the predetermined requirement, requesting resubmission of a candidate image.

According to another aspect of the invention, the graded card database is configured to be updated by at least one of: retrieving data from public websites and social media platforms, receiving data from grading entities, and receiving data from a user. In addition, providing the graded card database may further comprise, when obtained data comprises an image of a graded card, processing the image into a standardized image. Furthermore, processing the image may comprise processing the image through at least one of contrast enhancement, image enhancement, noise reduction, edge detecting and sharpening, alignment, and resizing.

According to another aspect of the invention, the system may further comprise a card value database comprising of: grade information, identifying attributes, price of each transacted card; and the method may further comprise: selecting one or more value comparison cards from the card value database based on the identifying attributes and the likely grade of the object card; and determining a likely range of values of the object card based on the likely score and the identifying attributes of the object card. Furthermore, the card value database may be configured to be updated by at least one of: retrieving data from public and private marketplaces, receiving data from grading entities, and receiving data from a user.

### BRIEF DESCRIPTION OF DRAWINGS

The foregoing summary, as well as the following detailed description of the preferred embodiments, will be better understood when read in conjunction with the appended drawings. It should be understood, however, that the invention is not limited to the precise arrangements and instrumentalities shown. In the drawings,

FIG. 1 illustrates an embodiment of a computing system environment in which an embodiment of the invention may be implemented;

FIG. 2 illustrates an embodiment of a network environment in which an embodiment of the present invention may be implemented;

FIG. 3 illustrates an example of multi-tier client server architecture in which an embodiment of the invention may be implemented;

FIG. 4 is a block diagram illustrating the function structure of the system for probabilistic determination of a likely grade of a collectible card according to an embodiment of the invention;

FIG. 5 is a flow chart illustrating the routine for the probabilistic determination of the likely grade of an object card according to an embodiment of the present invention;

FIG. 6 is a flow chart illustrating the image processing and quality control routine according to an embodiment of the present invention;

FIGS. 7A-7C illustrate some examples of the card images; and

FIGS. 8A-8C illustrate an example of similarity determination between two images of sports cards according to an embodiment of the invention.

### DETAILED DESCRIPTION

A preferred embodiment will be set forth in detail with reference to the drawings, in which like reference numerals refer to like elements or steps throughout.

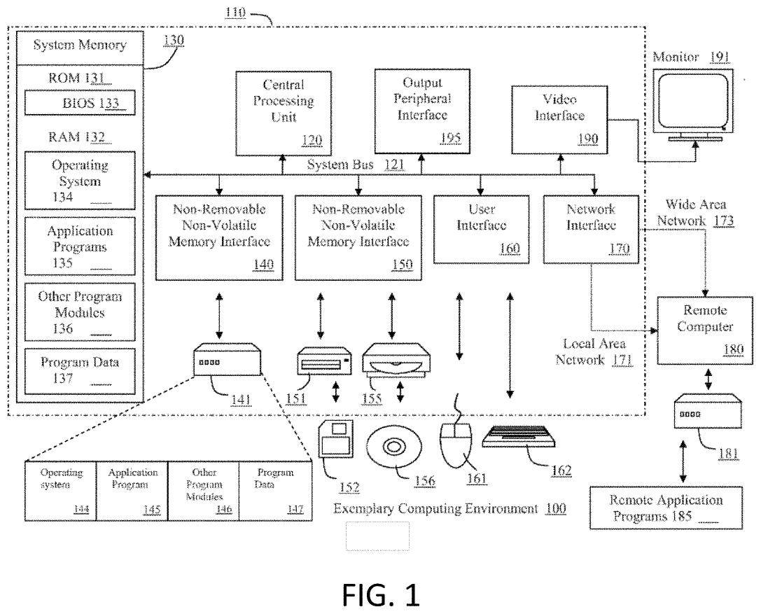

Below, examples of computing system, network environment, and client-server environment including cloud computing in which the embodiments of the present invention may be implemented are described by referring to FIGS. 1-3.

Example Computing Environment

FIG. 1 and the following discussion are intended to provide a brief general description of a suitable computing environment in which an example embodiment of the invention may be implemented. It should be understood, however, that handheld, portable, and other computing devices of all kinds (e.g., smartphones, tablets and laptops) are contemplated for use in connection with the preferred embodiment. While a general-purpose computer is described below, this is but one example. The preferred embodiment also may be operable on a thin client or mobile device having network server interoperability and interaction. Thus, an example embodiment of the invention may be implemented in an environment of networked hosted services in which very little or minimal client resources are implicated, e.g., an app or a networked environment in which the client device serves merely as a browser or interface to the World Wide Web.

Although not required, the invention can be implemented via an application programming interface (API), for use by a developer or tester, and/of included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules maybe combined or distributed as desired in various embodiments. Moreover, those skilled in the art will appreciate that the invention may be practiced with other computer system configurations. Other well-known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or a combination of components illustrated in the exemplary operating environment 100.

With reference to FIG. 1, an example system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), and PCI-Express bus.

The computer 110 typically includes a variety of computer readable media. Computer readable media can be any available media that can be accessed by the computer 110 and include both volatile and nonvolatile, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, solid state drives (SSD), or any other medium which can be used to store the desired information and which can be accessed by the computer 110. Communication media typically contain computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and or program modules that are immediately accessible to and/or presently being operated on by the processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical medium. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, the hard disk drive 141 is illustrated as the storing operating system 144, application programs 145, other program modules 146, and program data 147. Note that these components can either be the same as or different from the operating system 134, application programs 135, other program modules 136, and program data 137. Operating system 144, application programs 145, other program modules 146, and program data 147 are given different numbers here to illustrate that, at a minimum, they are different. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to a monitor 191, computers may also include other peripheral output devices such as speakers and a printer (not shown), which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, hut may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes means for establishing communications over the WAN 173, such as the Internet, hi a networked environment, program modules depicted relative to the computer 110, or portions thereof, may be stored in the remote memory storage device. By way of example, and not limitation, FIG. 1 illustrates remote application programs 185 as residing on a memory device 181. Remote application programs 185 include, but are not limited to web server applications such as Microsoft® Internet Information Services (ITS)® and Apache HTTP Server which provides content which resides on the remote storage device 181′ or other accessible storage device to the World Wide Web. It will be appreciated that the network connections shown are exemplary and other means of establishing a communications link between the computers may be used.

One of ordinary skill in the art can appreciate that a computer 110 or other client devices can be deployed as part of a computer network. In this regard, the preferred embodiment pertains to any computer system having any number of memory or storage units, and any number of applications and processes occurring across any number of storage units or volumes. An embodiment of the present invention may apply to an environment with server computers and client computers deployed in a network environment, having remote or local storage. The preferred embodiment may also apply to a standalone computing device, having programming language functionality, interpretation, and execution capabilities.

Example Network Environment

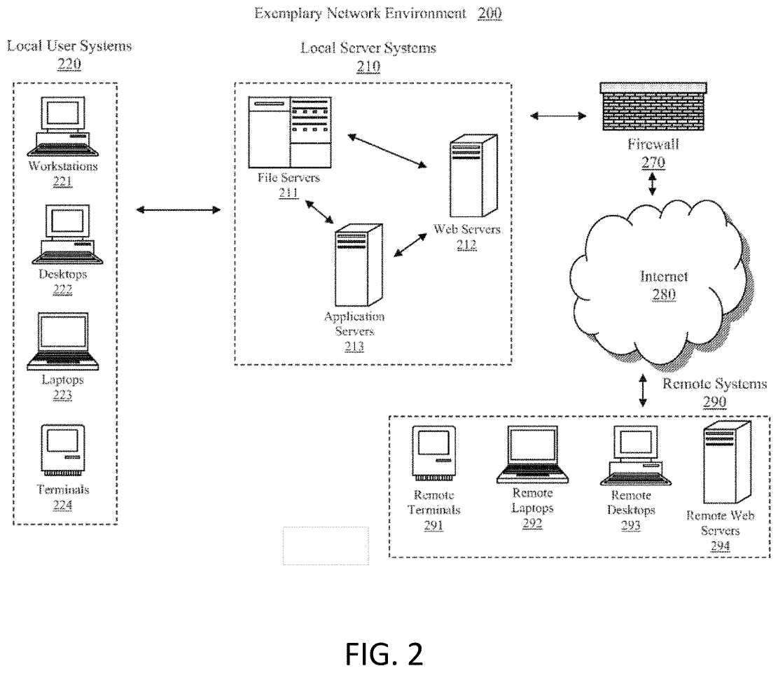

FIG. 2 illustrates an embodiment of a network environment in which an embodiment of the present invention can be implemented. The network environment 200 contains a number of local server systems 210, which may include a number of file servers 211, web servers 212, and application servers 213 that are owned and managed by the owner of the local network.

These servers are in communication with local user systems 220 which may include a large variety of systems such as workstations 221, desktop computers 222, laptop computers 223, and thin clients, smartphones, tablets, or terminals 224. The local user systems 220 may contain their own persistent storage devices such as in the case of workstations 221, desktop computers 222, and laptop computers 223. They can also have access to the persistent storage, such as a database, provide by the local servers 210. In the case of thin clients and terminals 224, network storage may be the only available persistent storage. The users within the local network usually get access to the wider area network such as the Internet 280 though the local server systems 210 and typically some network security measures such as a firewall 270. There might also be a number of remote systems 290 that can be in communication with the local server systems 210 and also the local user systems 220. The remote computer systems can be a variety of remote terminals 291, remote laptops 292, remote desktops 293, and remote web servers 294. FIG. 2 illustrates an exemplary network environment. Those of ordinary skill in the art will appreciate that the teaching of the present invention can be used with any number of network environments and network configurations.

Client-Server Environment

The client-server software architecture model is a versatile, message-based and modular infrastructure that is intended to improve usability, flexibility, interoperability, and scalability as compared to centralized, mainframe, time sharing computing. Client-server describes the relationship between two computer programs in which one program, the client is defined as a requester of services, which makes a service request from another program, the server is defined as the provider of services, which fulfills the request. A client-server application is a distributed system comprised of both client and server software. A client software process may initiate a communication session, while the server waits for requests from any client.

In a network, the client-server model provides a convenient way to efficiently interconnect programs that are distributed across different locations. Transactions among computers using the client-server model are very common. Most Internet applications, such as email, web access and database access, are based on the client-server model. For example, a web browser is a client program at a user computer that may be used to access information at any web server in the world. For a customer to check a bank account from a remote computer, a client program, which may run within a web browser, forwards a request to a web server program at the bank. The web server program may in turn forward the request to a database client program that sends a request to a database server at another bank computer to retrieve the requested account balance information. The balance information is returned back to the bank database client, which in turn serves it back to the web browser client in the customer's computer, which displays the information to the customer.

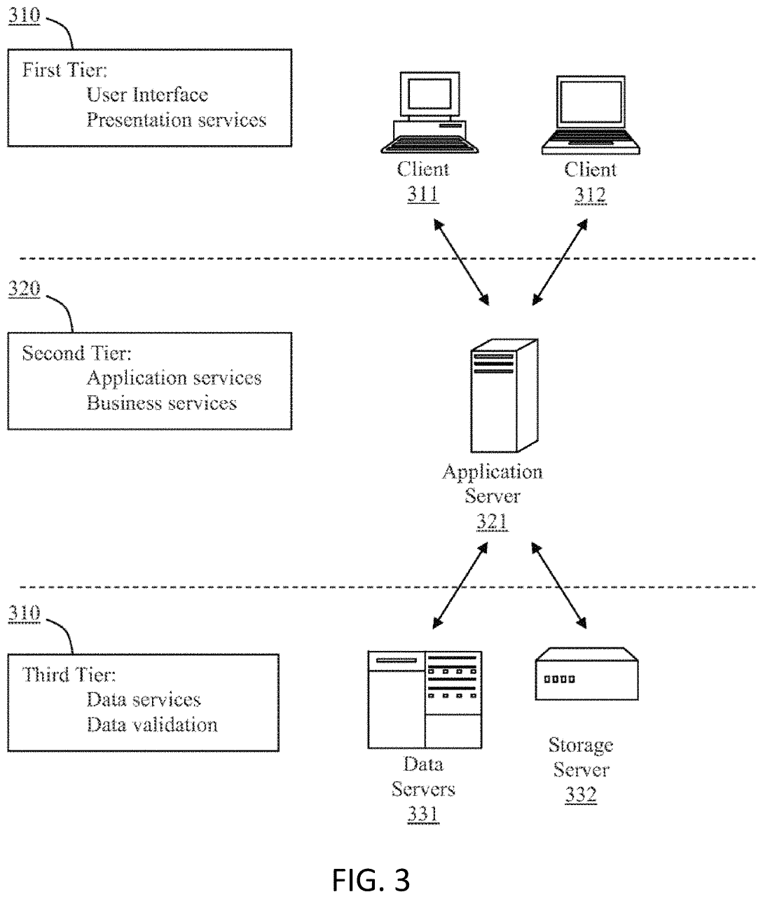

FIG. 3 illustrates an example of multi-tier client server architecture. Multi-tier client-server architecture allocates different tasks and services to different tiers. In the example multi-tier architecture of FIG. 3, there are three logical tiers. The first tier 310 is one or more clients 311, 312, the second tier is an application server 321, and the third tier 330 is a data server 331 332. At the client tier, the client's 311, 312 provide the application's User interface and also act as presentation servers. The application's graphical user interface is generally a custom-generated web page to be displayed by a web browser on the client computer. There can be one or more application servers 321 that host the business logic, and one or more data servers 331, 332 to provide data storage and validation services. The main body of an application is run on a shared host 321. The application server 321 does not drive the graphical user interface, rather it shares business logic, computations, and a data retrieval engine. The presentation of data retrieved is handled by the presentation server at the client tier. With less software on the client systems, there are fewer security concerns. Application scalability, support costs, and installation costs are all more favorable when the software is concentrated on a single server than when the software is distributed amongst a number of desktop clients.

In the embodiments of the present invention, the system and method for grade estimation of collectible objects are designed to be implemented in a network mode by at least one computing system, an example of which is shown by FIG. 1 and discussed above, in a network environment, an example of which is shown by FIG. 2 and discussed above. In the network mode, the system and method for grade estimation of collectible objects receive and output data from and to a user and at least one database in a client-server environment, an example of which is shown by FIG. 3 and discussed above. In the embodiments of the present invention, when the digital marketing management system and method receive and output data from and to a user, the system and method for grade estimation of collectible objects may be implemented as the server side, while the user may use a terminal or a computing system as the client side. On the contrary, when the system and method for grade estimation of collectible objects receive and output data from and to a database server, the system and method may be implemented as the client side, while the database server as the server side. However, the system and method for grade estimation of collectible objects according to some other embodiments may also run in a stand-along mode on a computing system without a network when the computing system has locally stored database, and is equipped with a camera or receives images from local storage.

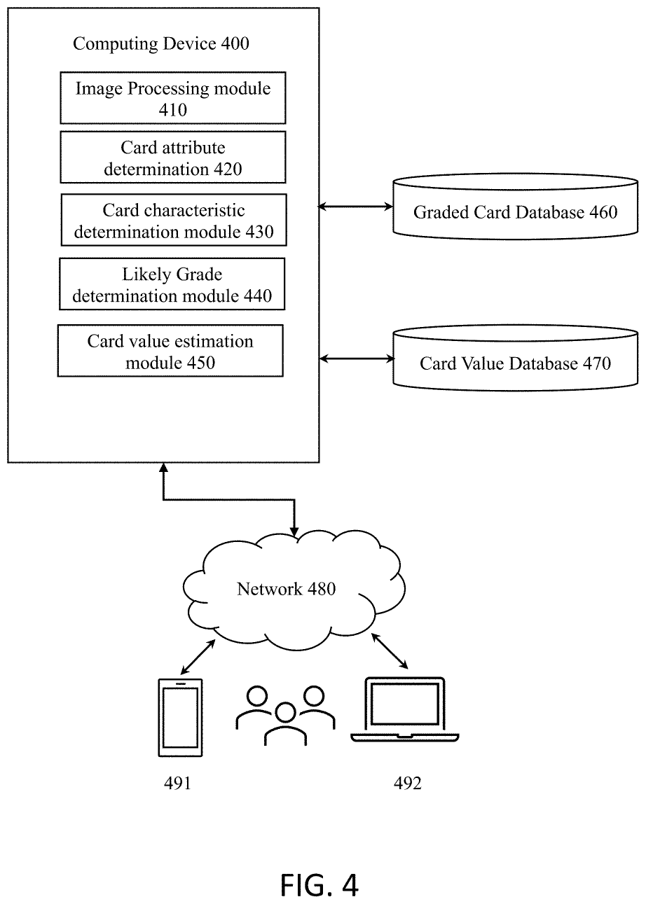

FIG. 4 is a block diagram depicting the function structure of a likely grade determination system 400 according to one embodiment of the present invention. As shown by FIG. 4, the system 400 is implemented as a computing device 400, which can be a general computing device as shown in FIG. 1 and usually comprises a processing unit and a storage with computer readable instructions. The computing device 400 may also be implemented by a cloud computing device as aforementioned. As shown in FIG. 4, the likely grade determination system 400 comprises an image processing module 410, a card attribute determination module 420, a card characteristic determination module 430, a likely grade determination module 440, a card value estimation module 450.

The computing device 400 is connected to and thus may exchange data with a graded card database 460 and a card value database 470. The graded card database 460 is a database of collectible cards (for example, sports cards) that have been graded by grading companies while the card value database 470 is a database of collectible cards that have been actually traded.

More specifically, the graded card database 460 has at least identifying attributes, physical characteristics and grade information of each stored graded card. The identifying attributes are information related to the content of the trading cards, such as, subject matter (for example, the athlete shown in the card), serial number (important to avoid storing duplicative data), manufacturer information (such as producer, vintage, holographic/design elements), and other optional information such as unique certification number for verification. The physical characteristics describe the information related to the grade of the card, which usually includes at least four criterions: centering, surface conditions (dimples, scratches, visible print lines), condition of edges, and condition of corners, which will be described in detail later. In one embodiment, this information can be numerical. For example, each of the four criterions can be described as a score in a range of 0-100. In another example, surface conditions can be described by a binary index, wherein 0 for a specific surface condition indicates there is no such defect while 1 indicates such defect is found on the card surface. The surface conditions may also be described by a score based on the degree of the defects. The grade information includes the grade and corresponding grading company. Some cards may be graded by different grading companies and thus may have more than one corresponding entries of grade information. In another embodiment, the graded card database 460 may further include images of the cards. These images are process to be standardized, which will be discussed later.

The card value database 470 is a database of traded cards. The card value database 470 similarly includes identifying attributes and grade information of the traded cards. The card value database 470 also include the trade information of the traded cards, which comprises at least the value of the traded card and may further comprise date, platform, and other information when a corresponding card was traded. In another embodiment, the card value database 470 may further include the characteristics and/or images of the traded cards.

Both of the graded card database 460 and the card value database 470 may be constantly updated by, for example, retrieving data from public websites and social media platforms, receiving data from grading companies, and receiving data from a user. The data may be obtained from numerous publicly available and proprietary sources including, but not limited to, eBay, Instagram, Facebook, Twitter, private collections, client submissions, and the grading companies' registry. End users may also be allowed to submit data of graded cards or traded cards.

As shown in FIG. 4, the system 400 may also interact with the users through network 480. The users may submit images of an object card and receive the likely grade or estimated value through a client device such as a smart phone 491 or a personal computer 492. The users may also submit information of traded or graded cards through the same way so that the system 400 may add entries to the graded card database 460 and the card value database 470.

System and Process Overview

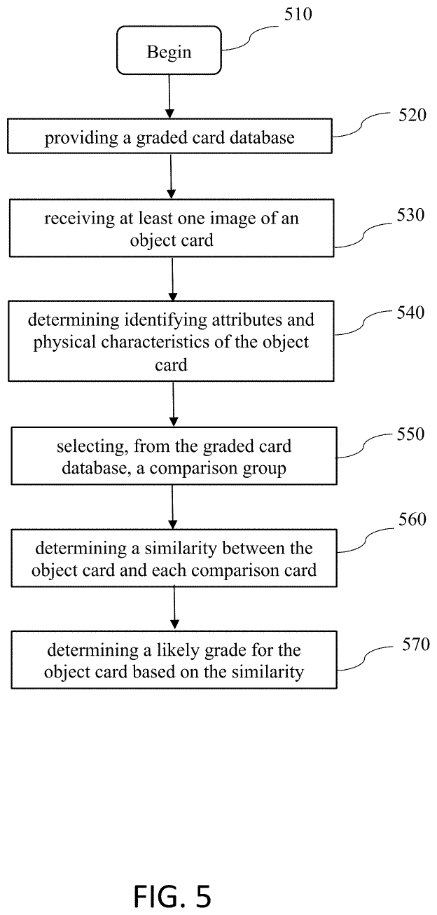

Below, the general process for probabilistic determination of a likely grade on an object card that a user submits will be described by referring to FIG. 5. FIG. 5 is a flow chart of the probabilistic determination of the likely grade of an object card according to one embodiment of the present invention.

As shown in FIG. 5, the process begins at step 510 when the system 400 is getting ready for probabilistic determination of a likely grade on an object card that a user submits. The process then goes to step 520, which provides a graded card database 460 as aforementioned. If the graded card database 460 has already been provided, the process may skip the step 520 and jump to step 530 when a user requests a probabilistic determination of a likely grade on a card.

At step 530, the process receives at least one image of the object card. In a client-server environment, the image may be submitted through a client device such as a smart phone, a tablet or a computer. If the client device has a camera, the process may also provide an option for the user to take one or more images of the object card and then submit the images. In another embodiment where the process is running locally on a user's computing device, the process may just receive at least one image of the object card stored on the computing device or from the camera that is install on the computing device. At step 530, the images that are received will also be standardized and then determined if they meet the requirement for the next steps, which will be described in detail below regarding image processing and quality control.

The process then goes to step 530. The process determines the identifying attributes and physical characteristics of the object card based on the one or more images received which has passed the quality control at step 520. As aforementioned, the identifying attributes are information related to the content of the sports cards, such as, subject matter (for example, the athlete shown in the card), serial number (important to avoid storing duplicative data), manufacturer information (such as producer, vintage, and parallel type, (for example, base card, and card with holographic or rare refractor, among other design elements)), and other optional information such as unique certification number for verification. The physical characteristics describe the information related to the grade of the card, which usually includes at least four criterions: centering, surface conditions (dimples, scratches, visible print lines), condition of edges, and condition of corners. The determination of identifying attributes and physical characteristics may be done by image processing and recognition, and in some examples, by machine learning. The details will be described later.

Next, the process selects, from the graded card database, a comparison group potentially comprising a plurality of comparison cards based on the identifying attributes at step 550. The comparison card(s) are preferred to have the same or similar identifying attributes compared with the object card. It is also preferred that the comparison cards have a range of grades obtained from each grading company. The details will be described later.

Next, at step 560, the process compares the object card with the comparison card(s) and determines the similarity in the physical characteristics between the object card and the comparison card(s). Based on the result of step 560, the process will then estimate a likely grade that the object card may receive from a specific grading company and provide the estimate to the user.

The system 400 may thus estimate likely grades that an object card may receive at each grading company, therefore provide a guide for the users to decide which card they will submit to which company in order to maximize their return on investment. In other embodiments, the system 400 may provide an estimated range of values of the object card in addition to the likely grade and thus help the users make the decision even easier.

Below, the modules of the system 400 and the routines run by the system 400 according to the embodiments of the present invention will be described in greater detail.

Image Processing and Quality Control

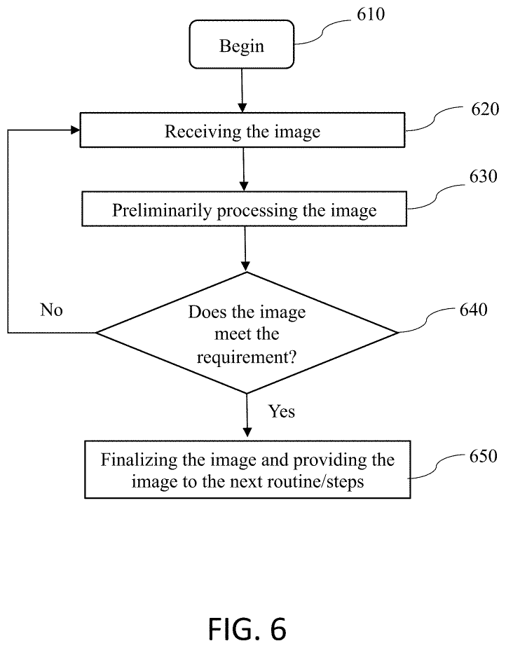

Below, image processing and quality control routine will be described by referring to FIG. 6. The image processing and quality control routine will be initiated by the image processing module 410 when receiving an image of an object card. It may also be applied when images of cards are added to the graded card database or the card value database.

As shown in FIG. 6, the image processing and quality control routine begins at step 610 and proceeds to step 620 to receive the image. When the system 400 is determining a likely grade of an objected card, an image of the object card is usually submitted by a user. If the user is using a client device with camera to take photos of the card, the system 400 may prompt at the client device with instructions on how to take quality photos and provide tools at the client device to facilitate alignment of the card, and use of flashlight, among others.

The routine then goes to step 630 to preliminarily process the image. For example, the routine detects the corners and edges of the card in the image and determines if there is distortion caused by the angle of the camera, the image will be transformed to align the card in a plan view. The routine may also adjust the image to reduce noise or adjust contrast.

The routine then further determines whether the image meets the requirement at step 640. For example, the routine will check if the image includes the full surface of the card, and also check whether qualitative and quantitative factors of the image will make the image suffice for use in the next steps. Some factors which would cause a card to be excluded could include, but are not limited to, alignment, noise in the images, low resolution, blurriness, and poor lighting.

If the image is determined to meet the requirement, the routine will go to the next step 650, to finalize the image and provide the image to the next steps or routines. Otherwise, the routine will return to the step 620 and request resubmission of the image. The finalization of the image may include, cropping the image along the outline of the card to capture only the card, adjusting resolution and contrast, removing noise and glare, among the others.

The image processing and quality control routine is also applicable to images from other sources than the user submission, for example, images retrieved from social medium or trading platforms. The image processing and quality control routine is also applicable when images of cards are added to the database such as the graded card database and card value database.

Determination of Identifying Attributes and Physical Characteristics

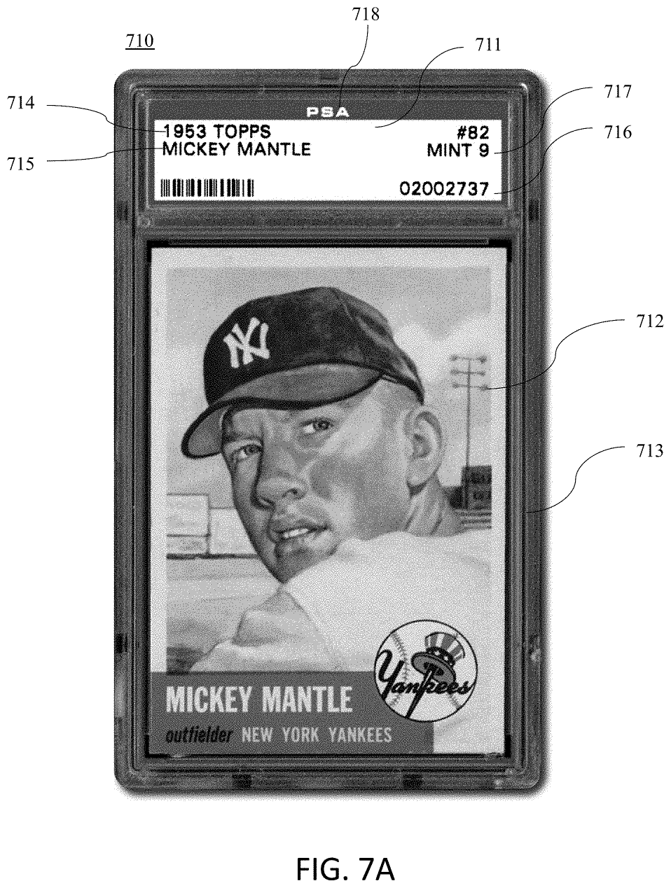

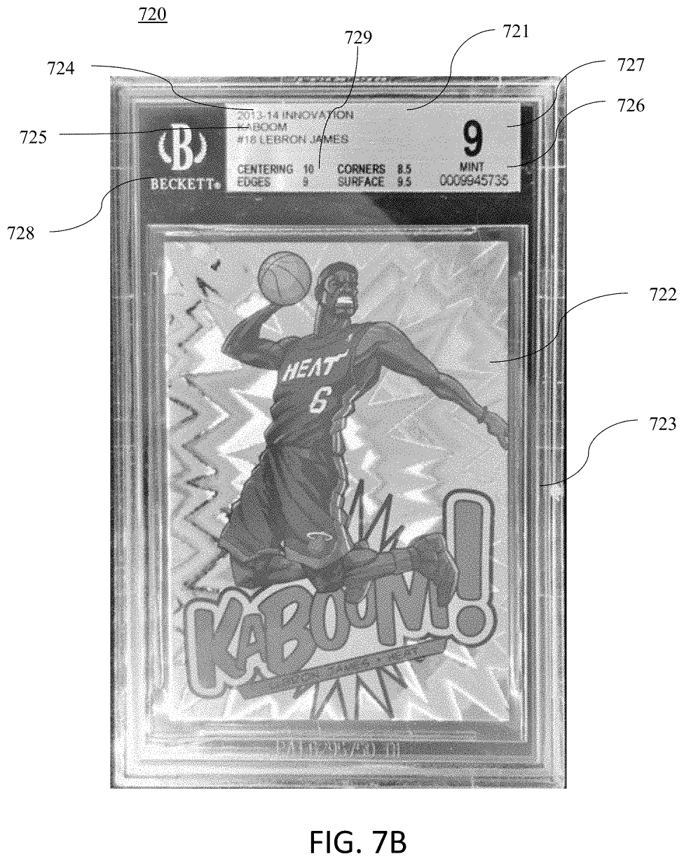

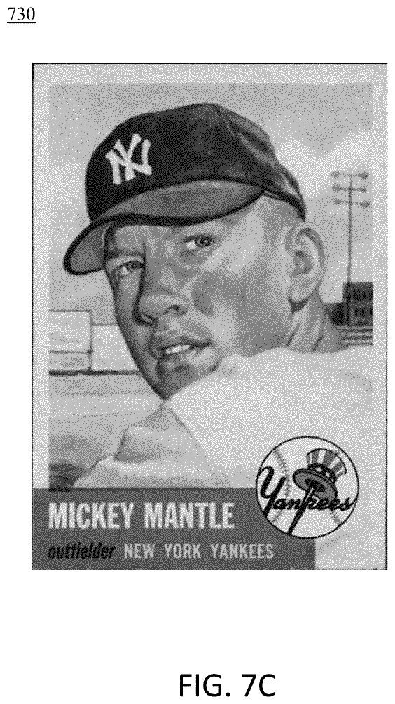

Below, the routine for determining identifying attributes and physical characteristics of an object card is described by referring to FIGS. 7A-7C. The routine is also an embodiment of step 540 as shown in FIG. 5.

FIGS. 7A-7C illustrate some examples of the card images that may be received. These images have been processed through the image processing and quality control, thus they are properly cropped and aligned. FIG. 7A is a front view of a graded card image 710. As shown by the image 710, the image include label 711 and the graded card 712 in a tamper-proof case, that is, slab 713. On the label 711, the identifying attributes of the card 712 are listed, including the manufacturer information 714, subject 715, grading company certification number 716. In the example shown in FIG. 7A, the manufacturer information 714 includes the manufacturer, TOPPS, and the vintage, year of 1953. The subject of the card is Mickey Mantle at 715. The label 711 also includes grade information which comprises the grading entity or company 718, in this case, PSA, and the grade 717, in this case, 9 out of 10.

FIG. 7B illustrates a front view of another graded card image 720. Similarly, the image 720 include the label 721 and the graded card 722 in a tamper-proof case, that is, slab 723. On the label 721, the identifying attributes of the card 722 are listed, including the manufacturer information 724, subject 725, certification number 726. The manufacturer information 724 includes the manufacturer and the vintage of the card. The subject of the card is listed at 725. The label 721 also includes grade information which comprises the grading entity or company 728. Different from the example shown in FIG. 7B, the grading information further includes the subgrades of the four criterions 729, that is, 10 for centering, 9.5 for corners, 9.5 for edges, and 9.5 for surface, in addition to the main grade 727 of 9.5.

FIG. 7C illustrate a front view of a raw card image 730. As shown in FIG. 7C, it simply is the front view of the card without label or slab.

When the system 400 received one or more images of an object card, usually the object card is a raw card. However, sometimes a user may want to know the likely grade a graded card may obtain from other grading companies or entities. Therefore, the system will also allow user to submit images of graded cards for the probabilistic determination.

Next, the determination of identifying attributes of an object card will be described. First, the routine will determine whether the object is graded or raw based on the one or more images. In another embodiment, the user can specify that they have uploaded a raw or graded card. It can be done simply by identifying at least one of the factors such as the aspect ratio of the image, the presence of the label or slab. For example, the image of a graded card is usually more elongated in the aspect ratio. The aspect ratio can be determined through the metadata of the image. The presence of the label or slab can be determined through, for example, OCR to recognized texts in the label, detecting a block area on the upper portion of the image, or image recognition by computer vision enhanced with machine learning. Some commercially available computer vision solutions include Google Vision and Amazon Rekognition.

If the routine determines that the image is of a graded card, the routine will determine the identifying attributes of the card by recognizing the content in the label. Otherwise, the routine will determine the identifying attributes based on the image. In one example, the routine may compare the image with the images stored in the graded card database and/or card value database, and use the identifying attributes of a matched entry of card in the database. Again, some commercially available computer vision solutions can be used, including Google Vision and Amazon Rekognition. If the routine fails to determine the identifying attributes of the object card, the routine may request a user to manually input the identifying attributes.

In another embodiment, the routine may provide the identifying attributes that are thus determined to the user for their confirmation. The routine may also allow the user to edit the identifying attributes.

In one embodiment, the routine for determining identifying attributes may further determine whether the object card is fake or the likelihood of the object card being fake. The determination of fake card can be done by machine learning and image recognition.

Below, the routine for determining physical characteristics will be described. As aforementioned, the physical characteristics are categorized into four criterions: centering, corners, edges, and surface. The methodology to determine the physical characteristics is to detect the defects in these four criterions and record them in a digital way.

Generally, the list below describes exemplary sub criterions in each of the four criterions to be considered when determining the physical characteristics.

1. Centering

Left/right and top/bottom position of the content on both the front and back of a card; image skew of the content.

2. Corners

The sharpness of the corners of a card; Angle, Residual, Fray and Fill; Discoloring; Dents; Chips; Folds; Crease; Scratches; Trimming.

3. Edges

Any visual wear and tear on the edges of a card; Cutting or trimming issues which could be picked up by the size of the card (e.g. trimmed cards will be smaller); Cutting resulting whiteness; Cutting and resulting subject dimensions; Laser cutting; Signs of bleaching (centering); Signs of coloring; Gluing; Stretching; Shrinking; Fraying; Sanding.

4. Surface

Gloss; Color (including no added color); Borders (including no bleaching or cutting); Misprinting/print defects; Mis-cut; Creases; Cracks; Folds; Chips; Scratches; Pin holes; Tape and other stains; Tears; Known Counterfeit Defects.

In one embodiment, recognition and determination of the sub criterions may be performed automatically with image processing and recognition, which, in some embodiments, may be enhanced by machine learning. Some of the sub criterions can be measured and expressed digitally. For example, regarding centering, the routine may determine a position of a card content relative to the physical center of the card, the skew angle of the card content relative the coordinate axis of the card. Regarding the corners, the angle of each corner or the difference of the angle relative to a right angle can be measured. Other sub criterions, especially defects such as folds, dents, punches, may be identified by image recognition enhanced by machine learning. For example, folds will be discoverable by the algorithm as the crease created by a fold will be clearly evident when compared against our graded card database. The image recognition and machine learning can also help identify key characteristics of a card that has been counterfeited, including if the card size falls within an acceptable level.

After all the criterions have been identified and determined, they will be recorded digitally as the physical characteristics of the card. Below, a few examples of how these physical characteristics are provided.

### Example 1.1

In this example, each sub criterion under each criterion is described by a figure or number. Those sub criterions that can be measured precisely may be recorded as its original figure or normalized figure. For example, the position of the center of the card content relative the card center as the origin, or the eccentricity ratio can be recorded. For the sub criterions, whether a defect is detected may be represented by a binary figure of 0 or 1, in which 0 indicates no such defect and 1 indicates the presence of such defect. Alternatively, a scale between 0 to 1 may be used to indicate the how serious the defect is. Therefore, all the numbers put together may form a matrix in which criterions are represented in rows while sub criterions are represented in columns, for example.

### Example 1.2

In addition to or as an alternative of example 1.1, the routine determines a sub grade in each criterion, for example, a sub grade in a scale of 0-10 for each of centering, corners, edges, and surface. In one embodiment, the sub grade may be calculated by the equation below: Gsub=F1*a1+F2*a2+ . . . Fn*an, wherein Fi, i=1−n, refers to a normalized score in each factor; ai, wherein i=1−n and n is an integer, refers to the weight of Fi; and the sum of “a1” to “an” equals to 100%.

### Example 1.3

In addition to or as an alternative of example 1.1 or 1.2, the routine may also simply just store the processed image of a card. In one embodiment, the routine may use the images of the whole cards. In another embodiment, the routine may further divide the images into smaller parts, such as images of the corners, edges, and surface. The images shall be processed to be standardized in terms of resolution, contrast, noise control, among the other.

Examples 1.1-1.3 are just exemplary embodiments of how to digitally describe physical characteristics of a card in terms of the criterions and sub criterions. A person of ordinary skills may employ other means to digitally describe the physical characteristics of a card.

After the routine has determined the identifying attributes and physical characteristics of a submitted object card, the routine will save the identifying attributes and physical characteristics and the system 400 is ready to estimate the likely grade the object card may receive at a given grading company. It can be understood that the routine for determining identifying attributes and physical characteristics may also apply when a card is added to the graded card database or the card value database.

Selection of Comparison Group

Below, the routine for selecting comparison group that corresponds to step 505 in FIG. 5 is described. After the identifying attributes of an object card have been determined, the routine will select, from the graded card database 460, a comparison group consisted of potentially a plurality comparison cards to compare the object card with.

The selection follows two basic rules: (1) the comparison cards are similar to or the same as the object card in the identifying attributes; (2) the comparison cards have a range of grades given by each grading company.

Ideally, the comparison group shall comprise a number of cards that may yield a result that is of statistical significance level. Depending on the size of the database, the number of cards can be predetermined to be 1, 10, 20, 50, or 100, for example. The comparison group shall comprise at least one card. In some embodiment, the number of cards can be in a predetermined range, for example, 1-20, 1-50, or 10-100. In addition, the comparison group shall also comprise cards that cover a predetermined wide range of grades. The range can be a subrange predetermined with 1-10, for example, or at least 3-10, or 4-9.5, or 9-10. Ideally, the range covers every possible grade from 1-10. When the data set of the graded cards is not sufficient to cover 1-10, a range within 1-10 can be selected cover the lowest grade and the highest grade in the cards selected in the comparison group. Alternatively, the range can be selected as one covers most of those seen on the market generally (for example, 3-9.5) or based on the identifying attribution of the object card that have been determined.

In one embodiment, the routine will try to find comparison cards that match the object card in identifying attributes. As aforementioned, the identifying attributes comprise at least subject matter, manufacture, set, vintage, and parallel type. Parallel type may indicate whether a card is of a base type, or a type with holographic or rare refractor, among other design elements. In one embodiment, the routine selects the comparison cards that have at least one same attribute as that of the object card, and preferably select the comparison cards that have more same attributes. In another embodiment, the routine begins with trying to first select the comparison cards from the graded card database that exactly match the object card, that is, cards that have all the same identifying attributes as the object card. If thus selected comparison cards are sufficient, for example, cover a variety of grades given by different grading companies, the routine stop choosing more comparison cards. Otherwise, the routine selects additional comparison cards that differ from the object card in only one identifying attribute. The routine keeps going until a sufficient number of comparison card have been selected. In further another embodiment, the routine also allocated priority orders for the attributes. For example, the routine may give priorities to subject matter and manufacture and will select the comparison cards with same subject matter and manufacture with priority. The routine may also consider the vintage of the cards and the time of grading if the graded card database also includes these entries. For example, when the comparison group lacks low grade cards, the routine may expand to search cards from other vintages/year. The routine may also prioritize cards that have been recently graded, because, for example, some companies are taking a slightly different criterion now than they did a few years ago.

Similarity Determination

After the comparison group has been selected, the system 400 will then run similarity determination routine to determine the similarity between the object card and the graded comparison cards in the comparison group, as the step 560 in FIG. 5.

In one embodiment, the similarity determination routine determined a similarity score of the object card against each comparison group in terms of the physical characteristics. Below, a few examples are described as embodiments of determining the similarity score.

### Example 2.1

In this example, the similarity determination routine determines a sub similarity score of the object card against each comparison group in each of the four criterions, and then determines an overall similarity score between the object card and each comparison card in the group.

When the system 400 describes the physical characteristics of a card with figures and numbers as described in Example 1.1 the similarity determination routine compares these numbers and figures in each criterion of the object card against a comparison card, and then determines a sub similarity score Si in each criterion. The similarity determination routine also considers the weight bi of each criterion when grading a card. Therefore, a simplified similarity score may be represented by the formula below:

S=S1*b1+S2*b2+ . . . Si*bn, wherein Si, i=1−n, represents sub similarity score in each criterion while bi, i=1−n, represents the weight of each criterion. The sum of b1 to bn shall equal to 100%.

When four criterions, that is, centering, corners, edges and surface are taken into account. The formula becomes S=S1*b1+S2*b2+S3*b3+S4*b4, wherein b1+b2+b3+b4=100%.

The weights of the criterions may be set at an initial value, example, equal weights for each criterion, and then be updated through machine learning by analyzing the weight of each criterion in the grading, when more entries of graded cards are fed into the graded card database. In some embodiments, when determining the weights of the criterions, the newly graded cards will be given more strength or weight. In some embodiments, the ultimate score cannot be any higher than one full point above the lowest sub-grade/criterion score.

### Example 2.2

Example 2.2 is similar to example 2.1 to determine the similarity score based on the difference in each criterion. In example 2.2, a multi-axis coordinate system may be set up. Each axis represents one criterion. The number of axes depends on the number of criterions that the routine takes into account. Since the physical characteristics of a card in each criterion can be quantized, each card, including the object card and a graded comparison card, may be represented by a point in a multi-dimensional space defined by the multi-axis coordinate system.

For example, when four criterions, centering, corners, edges, and surface are considered, each card becomes a point in the four-dimensional coordinate system. In another example, some important sub criterions (for example, crease, which may substantially decrease the grade if it exists) can be further considered and set as an additional axis.

The similarity score may be measured by the distance between points of the object card and a comparison card.

The coordinate system is extendable by adding more axes when more factors are to be considered, for example, the back surface of the card.

### Example 2.3

In this example, the similarity determination routine compares the images of the object card with the images of the comparison card and determines a similarity score. This similarity score is a measure of each of the four criterions of the object card against the four criterions of a comparison card. If the object card deviates from the graded card significantly, it would be assigned a lower similarity score.

In one example, the routine determines a similarity score in each criterion by comparing the images of the object card with the images of a comparison card, and then obtains an overall similarity score. The comparison may be performed based on the images regarding the centering, corners, edges, and surface, respectively, as obtained through the image processing module 410 and card characteristic determination module 440. Similar to example 2.1, the routine determines a similarity score Si in each criterion, and also considers the weight bi of each criterion when grading a card. Therefore, a simplified overall similarity score may be represented by the formula below:

S=S1*b1+S2*b2+ . . . Si*bn, wherein Si, i=1−n, represents sub similarity score in each criterion while bi, i=1−n, represents the weight of each criterion. The sum of b1 to bn shall equal to 100%. The weights of the criterions may be set at an initial value, example, equal weights for each criterion, and then be updated through machine learning by analyzing the weight of each criterion in the grading, when more entries of graded cards are fed into the graded card database.

In another example, the routine may determine an overall similarity score by comparing the full images of the object card with the full images of the comparison card and identifying the difference.

The image comparison may be enhanced by image recognition, such as SSIM, MSE, or PSNR. For example, the structural similarity index measure (SSIM) is a method for predicting the perceived quality of digital pictures, as well as other kinds of digital images and videos. SSIM is used for measuring the similarity between two images. The SSIM index is a full reference metric; in other words, the measurement or prediction of image quality is based on an initial uncompressed or distortion-free image as reference. SSIM is a perception-based model that considers image degradation as perceived change in structural information, while also incorporating important perceptual phenomena, including both luminance masking and contrast masking terms.

In other examples, the image comparison may be enhanced by neural networks and deep learning. The algorithm can be trained through a group of sample images, and learn to extract the features that represent surface, corners, edges and centering conditions instead of the content of the card itself. These features are extracted from an image, in a way that guarantees the same features will be recognized again even when rotated, scaled, or skewed. The features extracted this way can be matched against feature sets of other card images. Another image that has a high proportion of the features matching the learned ones by the algorithm is considered to be depicting the same physical condition. One simplistic technique is using Siamese Networks using Keras, and TensorFlow to compare similarity of images, bucketing them using thresholds, and training the algorithm with known images and using it to predict similarity between image pairings. Using Siamese Networks to compare two images for similarity results in a similarity score. The closer the score is to “1”, the more similar the images are and are thus more likely to belong to the same class (that is, grade).

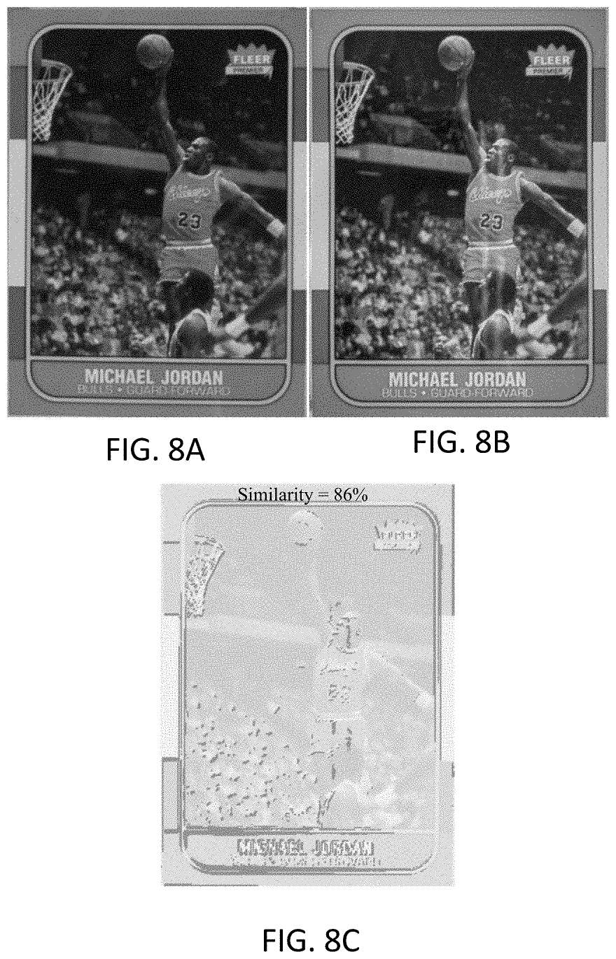

FIGS. 8A-8C illustrate an example of similarity determination between two images of sports cards. FIG. 8A illustrates an image of a comparison card while FIG. 8B illustrates an image of an object card. In this example, as shown FIGS. 8A and 8B, the object card has the same identifying attributes as those of the comparison card. FIG. 8C illustrate the raw result of similarity determination between the images shown in FIGS. 8A and 8B through the method of similarity scoring, using a “fuzz factor” of 50%. The fuzz factor utilizes a spherical representation of pixels, whereby each pixel has three dimensions of color (red, green, blue) and represents a point in the three dimensions—the fuzz factor is the radius of the sphere of the pixel, and a larger number allows for greater distance between pixels (therefore overlapping images with similar pixels have an opportunity to be within each other's sphere). The darkened dots and lines in FIG. 8C represent the differences between FIGS. 8A and 8B. Based on the differences, a quantified similarity score of about 86% may be determined, which is an approximation of the pixel count of those that are not darkened divided by total pixel count in FIG. 8C.

Alternatively, or in addition, the routine may be trained through machine learning to focus on the physical characteristics of a card identified in the images instead of the content, that is, the identifying attributes of the card. Some commercially available machine learnings protocols include google Vision and Amazon Rekognition. The algorithm can be fine-tuned to be more sensitive to physical conditions of the cards reflected in the images.

Likely Grade Determination

After the similarity scores of the object card against each of the comparison cards have been determined, the system 400 will then run a likely grade determination routine to determine the similarity between the object card and the graded comparison cards in the comparison group, as the step 570 in FIG. 5.

In one example, the likely grade determination routine simply chooses the grade of the comparison card against which the object card has the highest similarity score as the likely score. The likely grade determination routine may also categorize the comparison cards into sub groups based on the grading company that a comparison card is graded by, and chooses the grade of the comparison card that has the highest similarity score in each sub group as the likely grade the object card may probably obtained from a given grading company.

The likely grade determination routine may further set a condition of lower limit of the similarity score. For example, a lower limit of 80% or 90% in a scale of 1-100% of the similarity score may be predetermined. If only there is at least one card in the comparison group that has a similarity score greater than the lower limit, the likely grade determination routine continues to choose the grade of the comparison card that has the highest similarity score as the likely grade. Otherwise, the likely grade determination routine may return a “failure” as no conclusive result could be reached or may return to the comparison group selection routine to expand the comparison group by loosening the standards. Alternatively, instead of returning a “failure” notification, the likely grade determination routine may jump back to the routine for selecting comparison group to select an expanded comparison group with relaxed criterion. As another alternative solution, instead of returning a “failure” notification, the likely grade determination routine may also select cards that have a similarity score in each criterion that is higher than the lower limit and provide them to the user (or calculate a weighted average score as the likely score). For example, the routine may not be able to find a match of card with 80% or above similarity score, but find a first card graded PSA 9 that is 90% similar in centering, a second card graded PSA 8 that is 85% similar in corners, a third card graded PSA 7 that is 85% similar in edges, and a fourth card graded PSA 6 that is 80% similar in surface. The routine may provide these four cards to the user as a reference, or, alternatively, provide a likely grade=7.5 as the average of these four cards.

In another embodiment, the likely grade determination routine may provide a range as the likely grade. The likely grade determination routine may select the cards from the comparison group that have a similarity score greater than a predetermined lower limit, for example, 80% or 90% in a scale of 1-100%. If there are more than one cards selected, the lowest grade of the selected cards and the highest grade of the selected cards are provided as the lower and upper limits of the range of the likely grade. In this case, alternatively, the likely grade determination routine may also calculate a mean value of the grades of the selected card as the likely grade of the object card. When calculating the mean value, the similarity score may be further considered as the weight and a weighted mean value of the grades of the selected card is calculated as the likely grade of the object card.

When there are not enough cards in the comparison group for likely grade determination routine to determine a likely grade, the likely grade determination routine may return to the comparison group selection routine to expand the comparison group by including more cards. Alternatively, or in addition, the likely grade determination routine may convert a likely grade with another grading company to a likely grade with the given grading company by a formula. The formula may be preset or be learned and updated through machine learning based on the entries of graded cards in the graded card database.

Card Value Determination

In addition to likely grade determination, the system 400 may further provide an estimated card value or a range of possible values based on the card value database.

As aforementioned, the system 400 will continuously monitor and store all available sales data of traded cards in the card value database, leveraging marketplaces including but not limited to, eBay, mySlabs, Starstock and StockX. Those data include at least the identifying attributes, price, and grade information of the traded cards. The system 400 may also determine the identifying attributes and physical characteristics based on the images of the traded cards by the routines as aforementioned.

Based on the identifying attributes of the object card, the system 400 will select, from the card value database, at least one value comparison card, that is similar to the object card in terms of the identifying attributes and grade. The transacted price or the range of the transacted prices of the one or more value comparison cards is determined as the likely value or range of values of the object card. Alternatively, the system 400 may also provide a likely value that is calculated based on the weight of similarity in term of identifying attributes and grade. In a simplistic example, if the card is 70% similar to PSA 10s (sold for $6,000) and 30% similar to a PSA 9s (sold for $2,000), the system will generate a valuation range of $2,000 to $6,000 with a probabilistic valuation estimate of $4,800. In another example, only cards with a similarity score that is higher than a predetermined limit will be considered. The limit may be, for example, 60%, 70%, 80%, or 90%.

Alternatively, the system 400 may determine a rarity index based on the identifying attributes of a card that affects the trading value of the card independent to its grade. The rarity index and the relationship between the card value and both the rarity index and grade may be determined through machine learning based on the card value database. Generally speaking, the rarity index is related to the identifying attributes and independent of physical conditions of the card. Therefore, a simplistic example of the relationship could be: V=Base*R*G, wherein V represents the value, base represents a base value, R represents the rarity index, and G represents the grade. The system 400 may then determine the likely grade and rarity index of the object card and calculate the likely value of the object card based on its rarity index and likely grade.

Since rarity index is related to the identifying attributes. The system 400 may learn the relationship between the rarity index and the identifying attributes through machine learning. The relationship may be dynamic because the value is also affected by the supply and need of the market. Therefore, the system 400 may give more weight to newly transacted cards when deciding the rarity index and keep evolving when new entries of transacted cards are fed into the database. The rarity index may also be estimated based on specific relations between cards. For example, one way an estimate could be obtained is to compare the rare card to similar but less rare cards. For example, refractors are rare but base cards are not. In this case, we can use temporal multiplier to estimate a value.

### Example 3.1

The card database 470 indicated that in the past, a base card sells $500 on average and the rare refractor sells for $5,000 on average. This suggests that the rarer card is 10× more valuable.

The most recent transactions suggested that the base card doubles in value to $1,000. This would imply that the rare card could be valued at $10,000 (10×1,000). Therefore, the rarity index of the rare card may be doubled as well.

While the foregoing specification has been described with regard to certain preferred embodiments, and many details have been set forth for the purpose of illustration, it will be apparent to those skilled in the art without departing from the spirit and scope of the invention, that the invention may be subject to various modifications and additional embodiments, and that certain of the details described herein can be varied considerably without departing from the basic principles of the invention. Such modifications and additional embodiments are also intended to fall within the scope of the appended claims.

What is claimed:

1. A method for probabilistic determination of a likely grade for a collectible card, comprising:
providing a graded card database comprising identifying attributes, physical characteristics, and grade information of each of graded cards, wherein the grade information comprises grade and corresponding grading entity of the graded cards;
receiving at least one image of an object card;
determining identifying attributes and physical characteristics of the object card based on the at least one image;
selecting, from the graded card database, a comparison group including potentially a plurality of comparison cards based on the identifying attribute of the object card;
determining a similarity between the object card and each comparison card based on the physical characteristic; and
determining a likely grade for the object card based on the similarity.

2. The method of claim 1, wherein the identifying attributes comprise at least subject matter, manufacturer, vintage, and parallel type; and
wherein selecting the comparison group comprises selecting potentially a plurality of comparison cards that each have at least one same attribute as that of the object card.

3. The method of claim 2, wherein the comparison group comprises potentially a plurality of comparison cards having a range of grades selected within 1-10.

4. The method of claim 1, wherein determining a similarity comprises:
determining a similarity score in each characteristic between the object card and each comparison card; and
determining an overall similarity score between the object card and each comparison card based on the similarity scores in all characteristics.

5. The method of claim 4, wherein determining an overall similarity score further comprises determining an overall similarity score between the object card and each comparison card based on the similarity scores of each characteristic and a weight of each characteristic.

6. The method of claim 4, wherein determining the likely grade comprises identifying at least one comparison card having a highest overall similarity score to the object card, and reporting a grade of the at least one comparison card as the likely grade.

7. The method of claim 1, wherein the characteristics comprises at least one of edge, corner, centering, and surface defects.

8. The method of claim 1, wherein the graded card database further comprises at least one image of at least some of the graded cards.

9. The method of claim 8, wherein determining a similarity comprises determining a similarity score between the object card and each of comparison cards by comparing the at least one image of the object card and at least one image of the comparison card.

10. The method of claim 1, wherein receiving at least one image of an object card further comprises:
receiving at least one candidate image of the object card;
attempting recognition of edges and corners of the object card in the candidate image, and adjusting the candidate image; and
determining whether the adjusted candidate image meets a predetermined requirement.

11. The method of claim 10, wherein receiving at least one image of an object card further comprises:
if the candidate image meets the predetermined requirement, taking the candidate image as the image of the object card; and
if the candidate image does not meet the predetermined requirement but can meet the predetermined requirement if the candidate image was enhanced; and
if the candidate image does not meet the predetermined requirement and cannot be enhanced to meet the predetermined requirement, requesting resubmission of a candidate image.

12. The method of claim 1, wherein providing the graded card database comprises obtaining data by at least one of retrieving data from public websites and social media platforms, receiving data from grading entities, and receiving data from a user.

13. The method of claim 12, wherein providing the graded card database further comprises, when obtained data comprises an image of a graded card, processing the image into a standardized image.

14. The method of claim 12, wherein processing the image comprises processing the image through at least one of contrast enhancement, image enhancement, noise reduction, edge detecting and sharpening, alignment, and resizing.

15. The method of claim 1, further comprises:
providing a card value database comprising grade information, identifying attributes, price of each transacted card;
selecting at least one value comparison card from the card value database based on the identifying attributes and the likely grade of the object card; and
determining a likely value or range of values of the object card based on the likely score and the identifying attributes of the object card.

16. The method of claim 15, wherein providing the card value database comprises obtaining data by at least one of retrieving data from public and private marketplaces, receiving data from grading entities, and receiving data from a user.

17. A system for probabilistic determination of a likely grade for a collectible card, comprising:
a computing device; and
a graded card database comprising identifying attributes, physical characteristics, and grade information of each of graded cards, wherein the grade information comprises grade and corresponding grading entity of the graded cards;
wherein the computing device comprises at least one processor and memory coupled to the at least one processor, the memory comprising computer executable instructions that, when executed by the at least one processor, performs a method comprising:
receiving at least one image of an object card;
determining identifying attributes and physical characteristics of the object card based on the at least one image;
selecting, from the graded card database, a comparison group including potentially a plurality of comparison cards based on the identifying attribute of the object card;
determining a similarity between the object card and each comparison card based on the physical characteristic; and
determining a likely grade for the object card based on the similarity.

18. The system of claim 17, wherein the identifying attributes comprise at least subject matter, manufacturer, vintage, and parallel types; and
wherein selecting the comparison group comprises selecting potentially a plurality of comparison cards that each have at least one same attribute as that of the object card.

19. The system of claim 18, wherein the comparison group comprises potentially a plurality of comparison cards having a range of grades selected within 1-10.

20. The system of claim 17, wherein determining a similarity comprises:
determining a similarity score in each characteristic between the object card and each comparison card; and
determining an overall similarity score between the object card and each comparison card based on the similarity scores in all characteristics.

21. The system of claim 20, wherein determining an overall similarity score further comprises determining an overall similarity score between the object card and each comparison card based on the similarity scores of each characteristic and a weight of each characteristic.

22. The system of claim 20, wherein determining the likely grade comprises identifying at least one comparison card having a highest overall similarity score to the object card, and reporting a grade of the at least one comparison card as the likely grade.

23. The system of claim 17, wherein the characteristics comprises at least one of edge, corner, centering, and surface defects.

24. The system of claim 17, wherein the graded card database further comprises at least one image of at least some of the graded cards.

25. The system of claim 24, wherein determining a similarity comprises determining a similarity score between the object card and each of comparison cards by comparing the at least one image of the object card and at least one image of the comparison card.

26. The system of claim 17, wherein receiving at least one image of an object card further comprises:
receiving at least one candidate image of the object card;
attempt recognition of edges and corners of the object card in the candidate image, and adjusting the candidate image; and
determining whether the adjusted candidate image meets a predetermined requirement.

27. The system of claim 26, wherein receiving at least one image of an object card further comprises:
if the candidate image meets the predetermined requirement, or can be enhanced to meet the predetermined requirement, taking the candidate image as the image of the object card; and
if the candidate image does not meet the predetermined requirement, requesting resubmission of a candidate image.

28. The system of claim 17, wherein the graded card database is configured to be updated by at least one of retrieving data from public websites and social media platforms, receiving data from grading entities, and receiving data from a user.

29. The system of claim 28, wherein providing the graded card database further comprises, when obtained data comprises an image of a graded card, processing the image into a standardized image.

30. The system of claim 28, wherein processing the image comprises processing the image through at least one of contrast enhancement, image enhancement, noise reduction, edge detecting and sharpening, alignment, and resizing.

31. The system of claim 17, further comprises:
a card value database comprising grade information, identifying attributes, price of each transacted card; and
wherein the method further comprises:
selecting at least one value comparison card from the card value database based on the identifying attributes and the likely grade of the object card; and
determining a likely value or range of values of the object card based on the likely score and the identifying attributes of the object card.

32. The system of claim 31, wherein the card value database is configured to be updated by at least one of retrieving data from public and private marketplaces, receiving data from grading entities, and receiving data from a user.
